(19) United States
(12) Patent Application Publication
(10) Pub. No.: US 2015/0231039 A1
(43) Pub. Date: Aug. 20, 2015

(54) Apparatus for Containing Regurgitation

(71) Applicants: Joshua Boice, Burleson, TX (US); Clint Grimes, Crowley, TX (US)

(72) Inventors: Joshua Boice, Burleson, TX (US); Clint Grimes, Crowley, TX (US)

(21) Appl. No.: 14/183,131

(22) Filed: Feb. 18, 2014

(51) Int. Cl. A61J 19/00; B65D 33/18; B65D 33/00; B65D 25/22; B65D 25/10

(52) U.S. Cl. CPC A61J 19/00; B65D 25/22; B65D 25/10; B65D 33/004; B65D 33/18

(57) ABSTRACT

An apparatus used to contain waste for sanitary disposal by a user after experiencing nausea alone or in combination with diarrhea. The tray includes a bag dispensing system providing isolation between the user and the waste. The tray can be attached to a wide variety of objects thereby enabling sanitary containment in many locations.

### BACKGROUND

1. Field of the Invention

The present invention relates in general to the field of capturing, containment, and disposal of waste material typically vomited by a user.

2. Description of Related Art

There are many designs of containers to hold vomit well known in the art. Air sickness bags are typical containers for catching and containing vomit. The air sickness bags are typically foil lined bags with a folding wire clamp on the top of the bag. The wire can be pinched to secure the bag after the top of the bag has been folded in an attempt to seal the bag. Air sickness bags require the user to hold the bag to their mouth while vomiting. Air sickness bags do not seal well due to the imprecise nature of folding over the top of the bag and securing with a semi rigid metal strap to hold the fold in place. Additionally air sickness bags, because they are lined with foil to prevent seepage, do not allow for rapid measurement of the amount of vomit.

Another typical container for vomit is a toilet. Typically a user will vomit directly into a toilet. Vomiting into a toilet presents some limitations. First, toilets are fixed devices tied to running water and sewer drainage. While there are portable toilets suitable for recreational vehicles typically toilets are not suitable for moving vehicles. If a user is vomiting into a toilet then the toilet is not able to be used for containment and disposal of human excrement. Since diarrhea and vomiting can occur simultaneously a user that is sitting on the toilet is forced to find another suitable container for vomiting in such as a trash can. A trash can is a poor container for the containment of vomit. Trash cans must be held by the user while vomiting into them. Typically, trashcans are not empty therefore the amount of room to vomit could be limited. While there are many vomit containers well known in the art, considerable room for improvement remains.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a top View of the preferred embodiment of an apparatus for containing regurgitation according to the present application;

FIG. 2 is a side view of an alternative embodiment of an apparatus for containing regurgitation according to the present application;

FIG. 3 is a perspective view of the preferred embodiment of an apparatus for containing regurgitation according to the present application;

FIG. 4 is a perspective view of the preferred embodiment of an apparatus for containing regurgitation according to the present application;

FIG. 5 is a perspective view of an alternate embodiment of an apparatus for containing regurgitation attached to a wall according to the present application;

FIG. 6 is a perspective view of an alternate embodiment of an apparatus for containing regurgitation attached to a hospital bed table according to the present application

FIG. 7 is a perspective view of an alternate embodiment of an apparatus for containing regurgitation attached to a headrest in an automobile according to the present application;

FIG. 8 is a perspective view of an alternate embodiment of an apparatus for containing regurgitation attached to a wheelchair according to the present application; and

FIG. 9 is a perspective view of an alternate embodiment of an apparatus for containing regurgitation attached to a walker according to the present application.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the apparatus for containing regurgitation are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

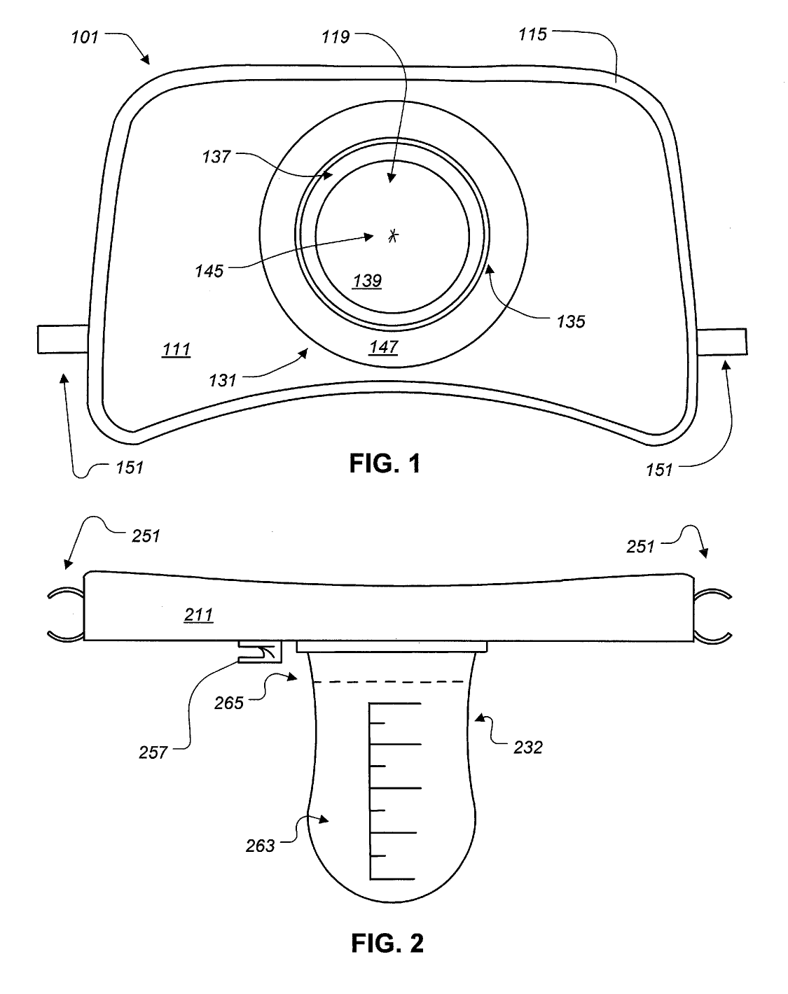

Referring to FIG. 1 in the drawings, a preferred embodiment of an apparatus for containing regurgitation 101 according to the present application is illustrated. The apparatus for containing regurgitation 101 includes a tray 111, a bag system 131, and a securing means 151 to secure the apparatus 101 to a structure in order for the apparatus 101 to be self supporting. Securing means 151 are clamps such that the apparatus is universally mountable. While securing means 151 are shown on either end of the tray 111, it should be apparent that the securing means could be located on a lower surface of the tray 111. Thereby allowing the user to remove the tray 111 from the mounting location by pulling up on the tray 111.

Tray 111 is preferably fabricated from plastic so that the user may readily clean and sanitize the tray 111. Even though plastic is the preferred material it should be apparent that the tray could be made of other suitable materials like metal, wood, composites, or glass so long as the material can readily be sanitized and is capable of supporting the force of the user leaning on it. Considering portable use of the tray 111, the tray 111 needs to be light enough that an elderly user can move the tray 111 without undue burden.

In an effort to retain the fluids and solids directed towards the tray 111, the tray 111 features a raised lip 115. The raised lip 115 is located around the outer edge of the tray 111 so that any errant liquids tend to stay on the tray 111 and not run off the edges of the tray 111.

In the center of the tray 111 is a hole 119. Hole 119 should be of suitable diameter such that a stream of nausea can readily be contained. If the hole 119 is too small then material will be caught by the tray 111. If the hole 119 is too large then the tray would be too flimsy. Typically the diameter of hole 119 is approximately 6-7 inches. Located in and adjacent to the hole 119 is the bag system 131. Bag system 131 is centered around the hole 119.

Bag system 131 is preferably a bag dispensing system 135. Bag dispensing system 135 is comprised of a removable ring shaped container 137 and a storage of disposable bags located in the removable ring shaped container 137. The user would typically extract a length of bag 139 or plastic tubing from the container 137 and tie a knot 145 into the end of the length of bag 139. The bag 139 is preferably made of several layers of plastic in order to prevent leaks and tears while thick enough to hold the waste. Furthermore, bag 139 is preferably clear or transparent such that the contents of the bag after use are clearly visible to users. Other embodiments have a bag 139 that while not transparent is translucent such that the contents are still readily visible. The purpose of the knot 145 is to seal one end. Other types of seals other than knots are possible such as using adhesive such as double sided tape or heat forming the seal. The untied end of the length of bag material would remain located inside container 137 thereby forming a closed end vessel to contain vomit. In order to maintain sanitary conditions a cover 147 seals the top of the container 137 to prevent fluids and debris from contaminating the container 137 or the bags 139 stored inside the container 137. Cover 137 is preferably made of a foam material to maintain comfort. Since a user would typically have their face adjacent or nearly adjacent to the cover 137 while using the tray the material of cover 137 needs to be capable of being sanitized but not uncomfortable to the user.

Referring now also to FIG. 2 in the drawings, an alternative embodiment of an apparatus for containing regurgitation 201 according to the present application is illustrated. Apparatus 201 includes a tray 211, a bag system 232, and securing means 251. Bag system 232 is a preformed vessel that is designed to be disposable. At the top of the bag system 232 would be a ring compatible with the opening in tray 211. Located on the underside of tray 211 is a self contained cutter 257. Cutter 257 includes a blade suitable for cutting the bag system 232 and a guard to prevent the user from accidentally cutting themselves. Cutter 257 is configured such that the user holds the bag system on either side of the cutter 257 and pulls the bag system 232 through the cutter 257 and severs the bag system. Having the cutter 257 located near the bag system 232 precludes the user from needing a pair of scissors or similar tool to cut the bags.

An alternative embodiment of the bag system 232 includes a plurality of plastic tubing stored inside a ring shaped container. The ring shaped container is located on the underside of the tray 211 and keeps the plastic tubing clean while unused. Typically, the ring shaped container holds several yards of plastic tubing. The user selects a length of plastic tubing by removing the length from the ring shaped container. The user ties a knot into the far end of the plastic tubing from the ring shaped container to make a vessel secured at the top by the amount of plastic tubing still inside the ring shaped container. Once the user is done with the vessel, they remove another portion of plastic tubing and use the cutter 257 to sever the vessel from the remaining plastic tubing and repeat the process by tying another knot into the loose end of the plastic tubing. Additionally, the user can seal the severed vessel by tying a knot in the unknotted end to close the severed vessel. To aid the user in severing the vessel, the plastic tubing could include a weakened region such as a series of perforations that enable the user to easily tear the plastic tubing in a predetermined area to create vessels of predetermined length. These vessels of predetermined length also could include adhesive seals that allow the user to seal the various ends of the vessel without tying knots. Included with the predetermined length would be a graduated scale such that the vessel would indicate accurate volume of liquids when properly severed and sealed.

Located on the side of the bag system 232 is a graduated scale 263 for allowing users and doctors accurately measure the amount of regurgitation produced by the user. Preferably, the scale is measured in milliliters but other measures of liquid volume are contemplated by this application. In this embodiment the bag system 232 is comprised of single use pre-formed bags with a perforation 265 to allow the bag to be easily removed from the underside of the tray 211. The preformed bags have a first end that is open and a sealed second end. Additionally, the preformed bag includes a mounting ring near the open end to keep the first end open and to allow the preformed bag to be coupled to the tray 211. The perforation 263 removes the need for the bag to be pulled up through the hole in the tray 211, thereby reducing the chance of leaks. Additionally, chemical or heat pressure sensitive adhesive is located adjacent, both above and below the perforation 265 so the user can easily seal both the used bag and/or make a bottom for a new bag. Once the bag has been used, the mounting ring of the previous bag would be removed to make room for another single use preformed bag. The adhesive may require the use of a liner to prevent the preliminary adhesion before the dispensing of the bag. In that case, the user would remove the liner and press the side of the bag to the exposed adhesive thereby closing and sealing the bag.

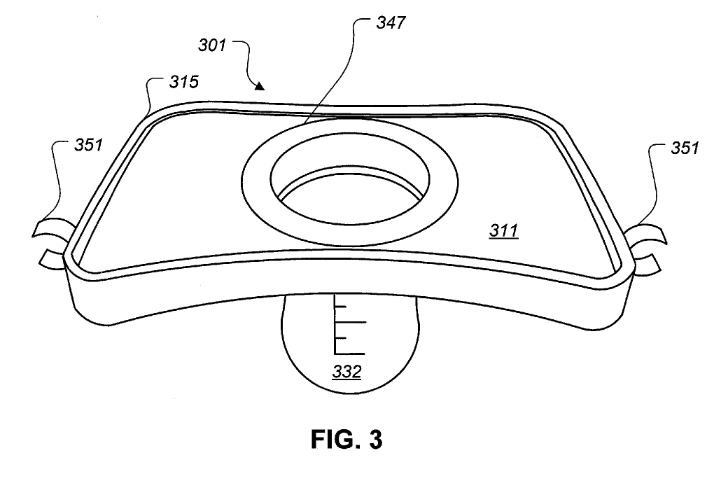

Referring now also to FIG. 3 in the drawings, an alternative embodiment of an apparatus for containing regurgitation 301 according to the present application is illustrated. Apparatus 301 includes a tray 311, a bag system 332, and clips 351. Clips 351 are designed to allow the tray to couple to a railing, such as those found on hospital beds and support rails located in restrooms. The tray 311 includes a lip 315 for helping to contain anything that misses the bag system 332. Cover 347 protects the unexposed parts of the bag system 332 from contamination and debris. While the tray 311 is illustrated as being flat, it should be apparent that the tray, in alternative embodiments, is sloped to aid in moving liquids from the tray into the bag system 332. In order for the graduated scale to remain accurate the bags include a line (not shown) to indicate to the user where to cut between bags. Additionally, the system includes a sealing cover that closes the hole of the tray thereby reducing the chance that something inadvertently falls into the hole and to reduce the odor and appearance of the regurgitation located in the bag system when used.

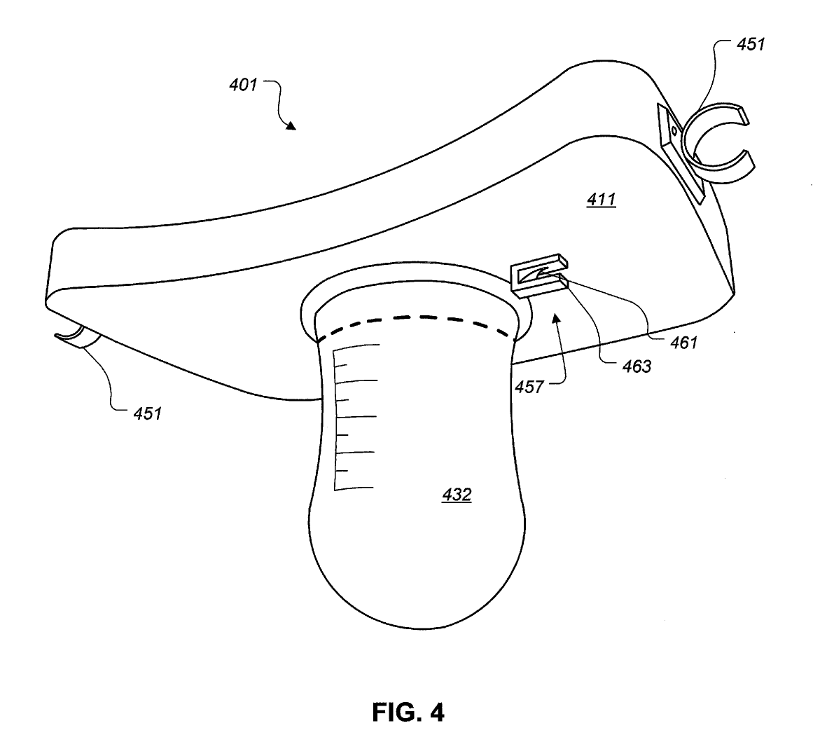

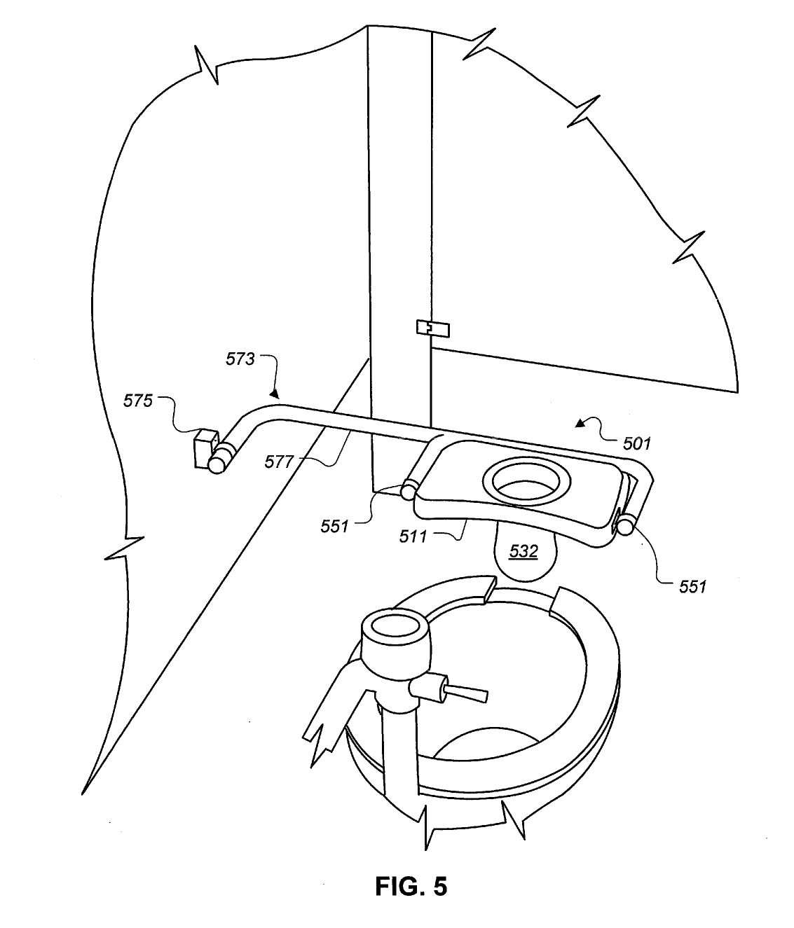

Referring now also to FIG. 4 in the drawings, an alternative embodiment of an apparatus for containing regurgitation 401 according to the present application is illustrated. Apparatus 401 includes a tray 411, a bag system 432, clips 451, and a severing system 457. Clips 451 utilize fasteners to mount the clips 451 to the tray 411. Severing system 457 has a blade 461 and a guard 463 to reduce access to the blade 461, thereby preventing accidents. Typically a user would select a length of bag from the bag system 432 and tie a knot in the end of the bagging system 432. Once the user had filled the bagging system 432 the user would select another length of bagging system 432 and use the severing system 457 to cut the filled portion of the bagging system 432. The user would then tie a knot in the filled portion above the filling to contain the contents thereby creating a container suitable for disposal. The user would restart the process again by selecting a length of bag system 432 and tie a knot in the end of the bagging system 432.

Referring now also to FIG. 5 in the drawings, an alternative embodiment of an apparatus for containing regurgitation 501 according to the present application is illustrated. Apparatus 501 includes a tray 511, a bag system 532, clips 551, a severing system (not shown), and a wall support system 573 or support member. Wall support system 573 has a wall mounted bracket 575 that allows the apparatus 501 to be rotated between a stored vertical position and a useable horizontal position, as shown. Because the apparatus potentially interferes with access to a toilet, having the apparatus 501 being able to be locally stored vertically and readily available at a moments notice provides users a safe, convenient, and sanitary system to use the restroom and contain regurgitation simultaneously or nearly simultaneously as needed. Wall support system 573 further comprises a support member 577 that is mechanically coupled to both the wall mounted bracket 575 and clips 551. Wall support system 573 is capable of supporting the tray 511 even when a user is resting on the tray 511 during use of the tray 511. Wall support system 573 provides the tray 511 with the ability to slide parallel to the ground relative to the user so that users can adjust the position of the tray 511 relative to them while sitting on the toilet. An alternative embodiment has the apparatus attached to assist rails located on the walls of the restroom near the toilet.

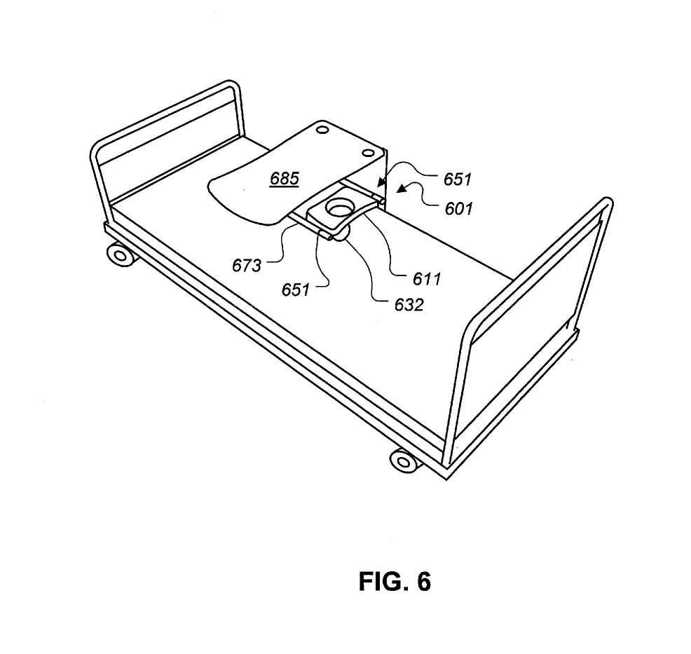

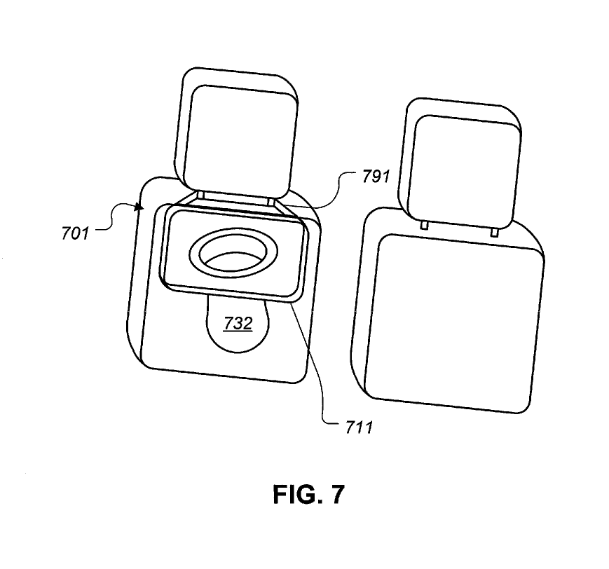

Referring now also to FIG. 6 in the drawings, an alternative embodiment of an apparatus for containing regurgitation 601 according to the present application is illustrated. Apparatus 601 includes a tray 611, a bag system 632, clips 651, a severing system (not shown), and a table support system 673. Because of the typical use of the apparatus 601 by those in hospitals, the apparatus is designed to interface directly with tables typical in hospital settings. Table support system 673 provides the tray 611 with the ability to be stored under the table 685 when not in use or to reduce odor and the appearance of the contents of the used apparatus 601. Typically, a nurse would come and remove the bag of regurgitation and the user would want to hide the contents by sliding the tray 611 underneath the table 685. This embodiment would be similar to that of a keyboard under the hospital tray table. An alternative embodiment has the apparatus clamped directly to the side of the bed with the ability to swing up as needed to allow access to the bed.

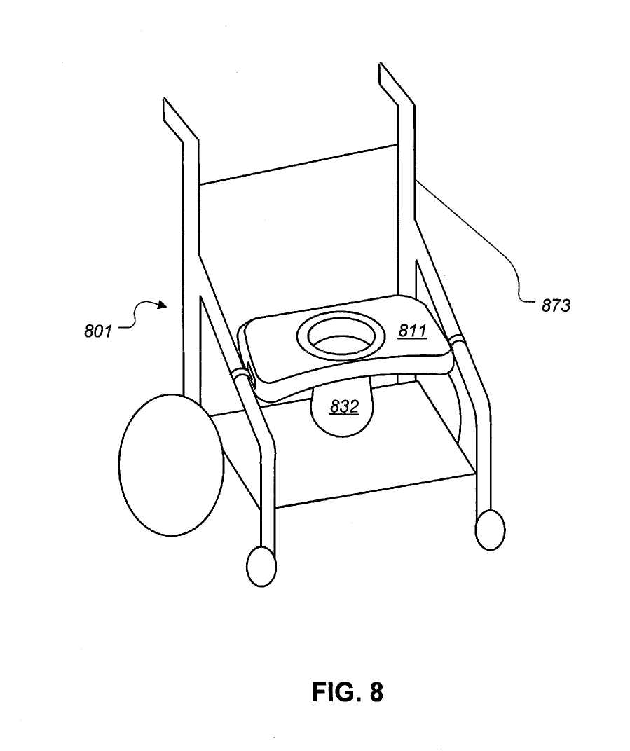

Referring now also to FIG. 7 in the drawings, an alternative embodiment of an apparatus for containing regurgitation 701 according to the present application is illustrated. Apparatus 701 includes a tray 711, a bag system 732, a severing system (not shown), and a table support system 773. Apparatus 701 as shown is designed to be supported by a headrest in the back seat of an automobile or airplane. Apparatus 701 provides a safe alternative for families going on a road trip incase of nausea. Table support system 773 includes a strap 791 for wrapping around the mounting post of a headrest. Table support system 773 also includes a buckle (not show) for allowing the table support system to adjust to various headrests with various dimensions. It should be apparent that other methods for supporting the tray 711 are contemplated by this application including arms with hooks, clips, and retractable cords. Any method to support the tray 711 must be able to hold the tray 711 and provide the user with an opening to the bag system 732. An alternative embodiment attached the apparatus to the seat tray table of airplane seat attached in a similar fashion to that of a keyboard through the use of brackets and sliding rails.

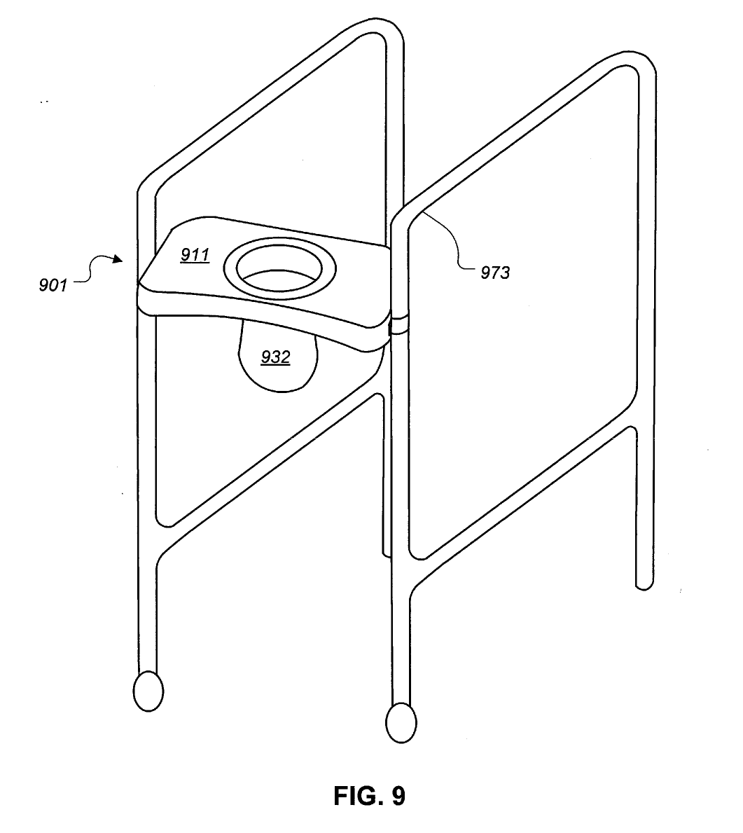

Referring now also to FIG. 8 in the drawings, an alternative embodiment of an apparatus for containing regurgitation 801 according to the present application is illustrated. Apparatus 801 includes a tray 811, a bag system 832, and a severing system (not shown). Apparatus 801 as shown is designed to be supported by the arms of a wheelchair 873. The apparatus 801 can be easily removed from the wheelchair 873 by unclipping the apparatus from the arms. While clips are shown supporting the tray 811 from the arms of the wheelchair, it should be apparent that other mounting methods are contemplated by this application, such as straps, magnets, and other fasteners so long as the apparatus is supported such that a user can rest upon the tray 811 and be supported while using the system and allows the tray 811 to be readily removed from the wheelchair so the user can get into and out of the wheelchair. This embodiment provides an advantage for those users that are located in a wheelchair and cannot readily use a conventional toilet for vomiting.

Referring now also to FIG. 9 in the drawings, an alternative embodiment of an apparatus for containing regurgitation 901 according to the present application is illustrated. Apparatus 901 includes a tray 911, a bag system 932, and a severing system (not shown). Apparatus 901 as shown is designed to be supported by the legs of a walker 973. While clips are shown supporting the tray 911 from the arms of the wheelchair, it should be apparent that other mounting methods are contemplated by this application, such as straps, magnets, and other fasteners so long as the apparatus is supported such that a user can rest upon the tray 911 and be supported while using the system. In this embodiment the tray 911 is an integral member of the walker and structurally keeps the sides of the walker 973 coupled together.

Other embodiments contemplated by this application include coupling the apparatus to the arms of a wheelchair, see FIG. 8, the arms of a walker, see FIG. 9, or to a table top or desk like surface. The apparatus is used to contain waste (food, vomit, etc.) for sanitary disposal by a patient, medical staff, or parent, and used when experiencing nausea or nausea/diarrhea simultaneously. Some of the benefits of the apparatus include: providing support and comfort to user by allowing for them to rest comfortably on toilet, bed, chair, etc. instead of kneeling or laying on the floor; simultaneous use of existing toilet in cases of nausea and diarrhea; allows for quick access in medical situations to a sanitary, comfortable, dignifying, waste management system; allows doctors to measure patients nausea/vomit in an effective way for treatment; and saves time and resources otherwise used to clean up overspill in bathrooms, bedrooms, hospital rooms, restrooms and transportation vehicles.

It is apparent that an assembly with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An apparatus for containing regurgitation, comprising:
a lipped tray, having a hole located in a center of the lipped tray;
a bag system located adjacent the hole; and
mounting hardware.

2. The apparatus for containing regurgitation according to claim 1, the bag system comprising:
a storage container;
plastic tubing located in the storage container; and
a safety cutter;
wherein a user removes a select length of plastic tubing from the storage container and ties a knot into the plastic tubing, thereby forming a sealed plastic container with an opening adjacent the hole.

3. The apparatus for containing regurgitation according to claim 2, the plastic tubing comprising:
a plurality of perforations for providing a weakened area of strength thereby aiding the user in severing the select length of plastic tubing.

4. The apparatus for containing regurgitation according to claim 3, the plastic tubing further comprising:
an adhesive strip located adjacent the plurality of perforations.

5. The apparatus for containing regurgitation according to claim 1, the bag system comprising:
a preformed bag, having;
a first open end;
a second sealed end; and
a mounting ring located adjacent the first open end;
wherein the mounting ring is configured to couple the preformed bag to the lipped tray.

6. The apparatus for containing regurgitation according to claim 5, the preformed bag further comprising:
a graduated scale.

7. The apparatus for containing regurgitation according to claim 5, the preformed bag further comprising:
a plurality of perforations located near the first open end;
wherein the plurality of perforations allow a user to sever the second sealed end from the mounting ring.

8. The apparatus for containing regurgitation according to claim 7, the preformed bag further comprising:
an adhesive strip located between the plurality of perforations and the second sealed end.

9. The apparatus for containing regurgitation according to claim 5, the mounting hardware comprising:
a wall mounted clamp;
a support member rotatably coupled to the wall mounted clamp;
a first clip coupled to the lipped tray; and
a second clip coupled to the lipped tray;
wherein the first clip and the second clip allow the lipped tray to be removably coupled to the support member.

10. A system for containing regurgitation, comprising:
a tray, having;
a hole; and
a raised portion; and
a bag system;
wherein the tray is sloped towards the hole.

11. The system for containing regurgitation according to claim 10, the bag system comprising:
a preformed bag, having;
a mounting ring located on a first end of the preformed bag;
a plurality of perforations; and
a sealed end located on a second end of the preformed bag opposite the first end;
wherein the mounting ring is configured to couple the preformed bag to the tray.

12. The system for containing regurgitation according to claim 11, the preformed bag further comprising:
a graduated scale.

13. The system for containing regurgitation according to claim 11, the preformed bag further comprising:
an adhesive located adjacent the plurality of perforations;
wherein the adhesive is configured to allow the user to seal the first end of the preformed bag, thereby forming a sealed bag; and
wherein the sealed bag can be removed from the tray by severing the preformed bag at the plurality of perforations.

14. The system for containing regurgitation according to claim 10, further comprising:
a first clip coupled to the tray; and
a second clip coupled to the tray;
wherein the first clip and the second clip allow the tray to be removably coupled to a wheelchair.

15. The system for containing regurgitation according to claim 13, further comprising:
a first clip coupled to the tray; and
a second clip coupled to the tray;
wherein the first clip and the second clip allow the tray to be removably coupled to a hospital table.

16. The system for containing regurgitation according to claim 10, further comprising:
a strap configured for securing the tray to a headrest.

17. The system for containing regurgitation according to claim 10, further comprising:
a walker;
a first clip coupled to the tray and coupled to the walker; and
a second clip coupled to the tray and coupled to the walker.

18. The apparatus for containing regurgitation according to claim 10, the bag system comprising:
a storage container located on a lower surface of the tray;
plastic tubing located in the storage container;
a safety cutter located on the lower surface of the tray; and
a ring shaped cover for sanitary protection of the plastic tubing;
wherein the storage container is centered around the hole; and
wherein a user removes a select length of plastic tubing from the storage container and ties a knot into the plastic tubing, thereby forming a sealed plastic container with an opening adjacent the hole.

19. The apparatus for containing regurgitation according to claim 10, further comprising:
a circular cover for sealing the hole.
